(19) United States
(12) Patent Application Publication
(10) Pub. No.: US 2023/0093925 A1
(43) Pub. Date: Mar. 30, 2023

(54) OFFLOADED CONTAINER EXECUTION ENVIRONMENT

(71) Applicant: Amazon Technologies, Inc., Seattle, WA (US)

(72) Inventors: Anthony Nicholas Liguori, Bainbridge Island, WA (US); Samartha Chandrashekar, Bellevue, WA (US); Nishant Mehta, Snoqualmie, WA (US)

(21) Appl. No.: 17/491,388

(22) Filed: Sep. 30, 2021

(51) Int. Cl. G06F 9/455; G06F 9/4401

(52) U.S. Cl. CPC G06F 9/45558; G06F 9/4406; G06F 2009/45562

(57) ABSTRACT

Disclosed are various embodiments for a container execution environment. In one embodiment, a container is executed in a virtual machine instance running on a computing device. A container control plane is executed separately from the virtual machine instance in an off-load device operably coupled to the computing device via a hardware interconnect interface. The container is managed using the container control plane executing on the off-load device.

### BACKGROUND

In operating system-level virtualization, an operating system kernel supports one or more isolated user-space instances. In various implementations, these user-space instances may be termed containers, zones, virtual private servers, partitions, virtual environments, virtual kernels, jails, and so forth. Operating system-level virtualization stands in contrast to virtual machines that execute one or more operating systems on top of a hypervisor.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C are drawings of examples of a container execution environment according to various embodiments of the present disclosure.

FIG. 2 is a schematic block diagram of a networked environment according to various embodiments of the present disclosure.

FIG. 3 is a schematic block diagram of a computing device having an off-load device according to various embodiments of the present disclosure.

FIG. 4 is a flowchart illustrating one example of functionality implemented as portions of a cloud provider network in the networked environment of FIG. 2 according to various embodiments of the present disclosure.

FIG. 5 is a flowchart illustrating one example of functionality implemented as portions of a migration service executed in a cloud provider network in the networked environment of FIG. 2 according to various embodiments of the present disclosure.

FIG. 6 is a schematic block diagram that provides one example illustration of a cloud provider network employed in the networked environment of FIG. 2 according to various embodiments of the present disclosure.

### DETAILED DESCRIPTION

The present disclosure relates to a container execution environment that may be deployed in cloud provider networks. More specifically, the present disclosure relates to the use of an off-load device for executing the container runtime and orchestration agent of a container executing on a server to which the off-load device is attached, in order to enable native support for containers in a virtualized compute service. Containers are an increasingly popular computing modality within cloud computing. A container represents a logical packaging of a software application that abstracts the application from the computing environment in which the application is executed. For example, a containerized version of a software application includes the software code and any dependencies used by the code such that the application can be executed consistently on any infrastructure hosting a suitable container engine (e.g., the DOCKER or KUBERNETES container engine). Existing software applications can be “containerized” by packaging the software application in an appropriate manner and generating other artifacts (e.g., a container image, container file, other configurations) used to enable the application to run in a container engine.

While virtual machine instances have been available for many years in cloud provider networks and other computing environments, developers are now moving to containers to package and deploy computational resources to run applications at scale. Containers embody operating system-level virtualization instead of system hardware-level virtualization. In contrast to virtual machine instances that include a guest operating system, containers share a host operating system and include only the applications and their dependencies. Thus, containers are far more lightweight, and container images may be megabytes in size as opposed to virtual machine images that may be gigabytes in size. For this reason, containers are typically launched much faster than virtual machine instances (e.g., milliseconds instead of minutes) and are more efficient for ephemeral use cases where containers are launched and terminated on demand.

Cloud provider networks offer container execution environments as a service under an elastic, utility computing model. For example, a cloud provider network may keep a pool of physical or virtual machine instances active so that containers can be launched quickly upon customer request. However, these container execution environments may have operating restrictions that may limit flexibility. In some cases, a container execution environment may require that containers be stateless rather than stateful. In other words, a stateless container cannot keep track of state for applications within itself because the container execution environment does not serialize or update an image of the container having the modified state. Consequently, container state cannot be preserved in transferring a container from one system to another. Also, a container execution environment may not support live update or migration with respect to the operating system, container runtime, container orchestration agent, and/or other components. Lack of support for live update or migration means that a container instance will be terminated in order for the container execution environment to be updated.

Various embodiments of the present disclosure introduce a container execution environment that may allow for stateful containers and support live migration. The container execution environment executes the container control plane, including the container runtime and/or the container orchestration agent, separately from the operating system and machine instance that executes the container. This allows for the container control plane to be used for containers in multiple virtual machines in some embodiments. In one implementation, the container control plane is executed by a dedicated hardware processor that is separate from the processor on which the operating system and container executes. In another implementation, the container control plane is executed in a first virtual machine instance that is different from a second virtual machine in which the operating system and container instance are executed. As will be described, these arrangements allow the container control plane components to be updated without terminating the container instance. Additionally, the container execution environment may include a block data storage service to load container images more quickly and allow for stateful containers instances to be persisted as images.

As one skilled in the art will appreciate in light of this disclosure, certain embodiments may be capable of achieving certain advantages, including some or all of the following: (1) increasing the computational capacity of a cloud provider network by transferring backend container execution functionality from processor cores used by customers to separate processor cores, thereby freeing resources for the processor cores used by the customers; (2) improving the functioning of a container execution environment by allowing containers to be stateful and persist state; (3) improving the functioning of a container execution environment by supporting live update of container execution components without terminating container instances; (4) improving the performance of a cloud provider network by sharing a container runtime and a container orchestration agent among containers executed in multiple virtual machine instances; (5) improving computer system security by isolating the container control plane from customer-accessible memory; (6) improving the flexibility and security of computer systems by allowing for confidential computing where the customer-accessible memory can remain encrypted as distinguished from the memory in which the container control plane is executed; and so forth.

A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). Virtual machine technology can use one physical server to run the equivalent of many servers (each of which is called a virtual machine). While multiple virtual machines can run on one physical machine, each virtual machine typically has its own copy of an operating system, as well as the applications and their related files, libraries, and dependencies. Virtual machines are commonly referred to as compute instances or simply “instances.” Some containers can be run on instances that are running a container agent, and some containers can be run on bare-metal servers.

Containers are comprised of several underlying kernel primitives: namespaces (what other resources the container is allowed to talk to), cgroups (the amount of resources the container is allowed to use), and LSMs (Linux Security Modules—what the container is allowed to do). Tools referred to as “container runtimes” make it easy to compose these pieces into an isolated, secure execution environment. A container runtime, also referred to as a container engine, manages the complete container lifecycle of a container, performing functions such as image transfer, image storage, container execution and supervision, and network attachments, and from the perspective of the end user the container runtime runs the container. A container agent can be used in some implementations to enable container instances to connect to a cluster. A container control plane, as described herein, can include the container runtime and, in some embodiments, the container agent.

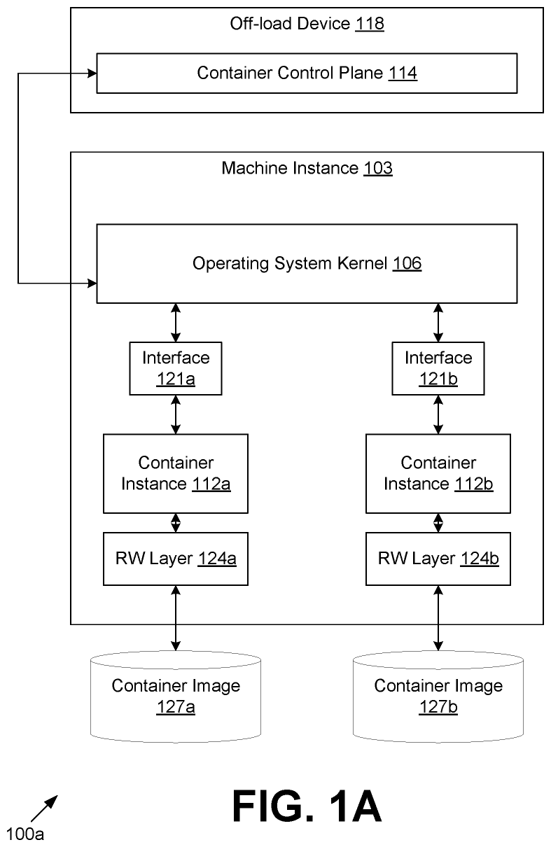

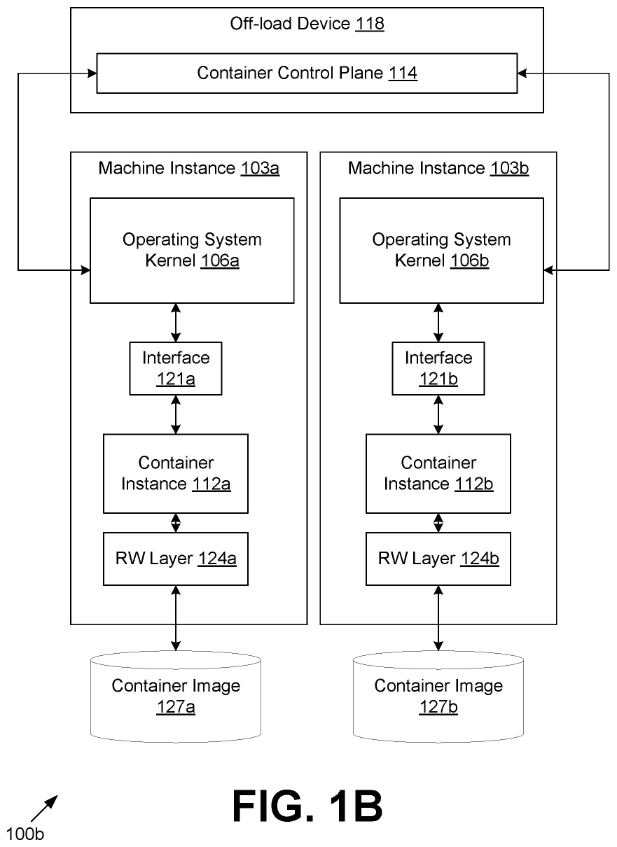

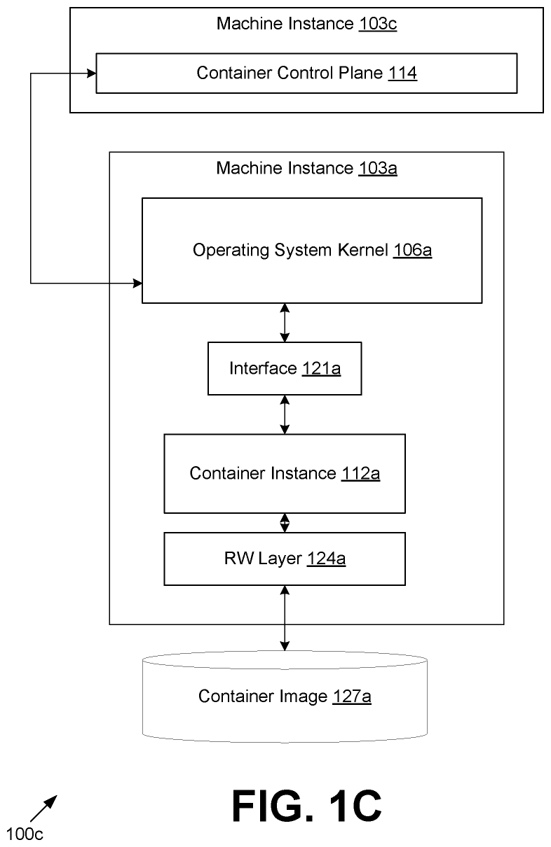

Referring now to FIG. 1A, shown is one example of a container execution environment 100a according to various embodiments. In FIG. 1A, a machine instance 103 executes an operating system kernel 106 and a plurality of container instances 112a and 112b. The container instances 112 may be referred to as “containers.” The container instances 112 may correspond to a pod or group of container instances 112. A container control plane 114 manages the container instances 112 by providing operating system-level virtualization to the container instances 112 via a container runtime, with orchestration implemented by a container orchestration agent.

Rather than have the container control plane 114 execute in the same machine instance 103 as the container instances 112, the container control plane 114 is instead executed in an off-load device 118 corresponding to special purpose computing hardware in the same computing device in which the machine instance 103 is executed. The off-load device 118 may have a separate processor and memory by which to execute the container control plane 114 so that the container control plane 114 does not use processor and memory resources of the machine instance 103. Instead, an interface 121a and 121b provides a lightweight application programming interface (API) shim to send calls and responses between the container control plane 114 executed in the off-load device 118 and the operating system kernel 106 and the container instances 112 executed in the machine instance 103. In some implementations, system security is enhanced by using the off-load device 118 in that a security compromise of the memory storing the container instances 112 would be isolated to that memory and would not extend to the container control plane 114 in the off-load device 118.

Additionally, respective read/write layers 124a and 124b enable the corresponding container instances 112a and 112b to read from and write to data storage, such as a block data storage service, that includes a respective container image 127a and 127b. As the state inside the container instances 112 is modified or changed, the container instances 112 having the modified state can be serialized and stored as the container images 127, thereby permitting the container instances 112 to be stateful rather than stateless.

Turning to FIG. 1B, shown is another example of a container execution environment 100b according to various embodiments. FIG. 1B, in contrast to FIG. 1A, shows a container execution environment 100b with a plurality of machine instances 103a and 103b, which may each execute respective operating system kernels 106a and 106b and one or more respective container instances 112a and 112b. For example, the machine instances 103 may be executed on the same computing device or on different computing devices. A single container control plane 114 executed in the off-load device 118 may perform the operating system-level virtualization for the container instances 112 in both of the machine instances 103a and 103b. In some cases, the machine instances 103 may correspond to different customers or accounts of a cloud provider network, with the machine instances 103 being a tenancy boundary.

Moving now to FIG. 1C, shown is another example of a container execution environment 100c according to various embodiments. Instead of executing the container control plane 114 in an off-load device 118 as in FIGS. 1A and 1B, the container execution environment 100c executes the container control plane 114 in a different machine instance 103c. The machine instances 103a and 103c may be executed in the same computing device or in different computing devices. In one implementation, the machine instance 103c may correspond to a cloud provider network substrate. In the following discussion, a general description of the system and its components is provided, followed by a discussion of the operation of the same.

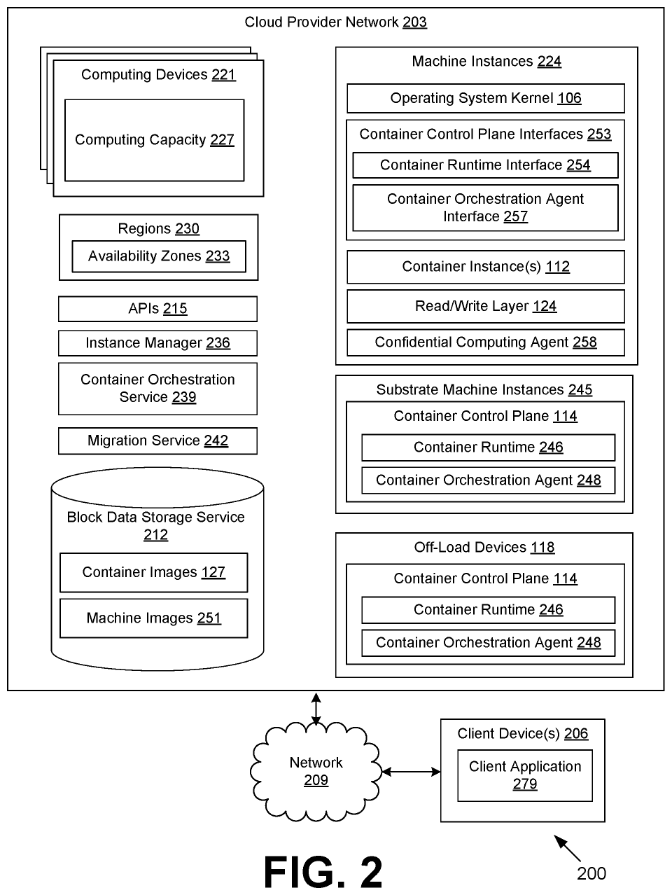

With reference to FIG. 2, shown is a networked environment 200 according to various embodiments. The networked environment 200 includes a cloud provider network 203 and one or more client devices 206, which are in data communication with each other via a network 209. The network 209 includes, for example, the Internet, intranets, extranets, wide area networks (WANs), local area networks (LANs), wired networks, wireless networks, cable networks, satellite networks, or other suitable networks, etc., or any combination of two or more such networks.

A cloud provider network 203 (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to a variable load. Cloud computing can thus be considered as both the applications delivered as services over a publicly accessible network (e.g., the Internet, a cellular communication network) and the hardware and software in cloud provider data centers that provide those services.

The cloud provider network 203 can provide on-demand, scalable computing platforms to users through a network, for example, allowing users to have at their disposal scalable “virtual computing devices” via their use of the compute servers (which provide compute instances via the usage of one or both of central processing units (CPUs) and graphics processing units (GPUs), optionally with local storage) and block data storage services 212 (which provide virtualized persistent block storage for designated compute instances). These virtual computing devices have attributes of a personal computing device including hardware (various types of processors, local memory, random access memory (RAM), hard-disk, and/or solid-state drive (SSD) storage), a choice of operating systems, networking capabilities, and pre-loaded application software. Each virtual computing device may also virtualize its console input and output (e.g., keyboard, display, and mouse). This virtualization allows users to connect to their virtual computing device using a computer application such as a browser, API, software development kit (SDK), or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires.

As indicated above, users can connect to virtualized computing devices and other cloud provider network 203 resources and services using one or more application programming interfaces (APIs) 215. An API 215 refers to an interface and/or communication protocol between a client device 206 and a server, such that if the client makes a request in a predefined format, the client should receive a response in a specific format or cause a defined action to be initiated. In the cloud provider network context, APIs 215 provide a gateway for customers to access cloud infrastructure by allowing customers to obtain data from or cause actions within the cloud provider network 203, enabling the development of applications that interact with resources and services hosted in the cloud provider network 203. APIs 215 can also enable different services of the cloud provider network 203 to exchange data with one another. Users can choose to deploy their virtual computing systems to provide network-based services for their own use and/or for use by their customers or clients.

The cloud provider network 203 can include a physical network (e.g., sheet metal boxes, cables, rack hardware) referred to as the substrate. The substrate can be considered as a network fabric containing the physical hardware that runs the services of the provider network. The substrate may be isolated from the rest of the cloud provider network 203, for example it may not be possible to route from a substrate network address to an address in a production network that runs services of the cloud provider, or to a customer network that hosts customer resources.

The cloud provider network 203 can also include an overlay network of virtualized computing resources that run on the substrate. In at least some embodiments, hypervisors or other devices or processes on the network substrate may use encapsulation protocol technology to encapsulate and route network packets (e.g., client IP packets) over the network substrate between client resource instances on different hosts within the provider network. The encapsulation protocol technology may be used on the network substrate to route encapsulated packets (also referred to as network substrate packets) between endpoints on the network substrate via overlay network paths or routes. The encapsulation protocol technology may be viewed as providing a virtual network topology overlaid on the network substrate. As such, network packets can be routed along a substrate network according to constructs in the overlay network (e.g., virtual networks that may be referred to as virtual private clouds (VPCs), port/protocol firewall configurations that may be referred to as security groups). A mapping service (not shown) can coordinate the routing of these network packets. The mapping service can be a regional distributed look up service that maps the combination of an overlay internet protocol (IP) and a network identifier to a substrate IP so that the distributed substrate computing devices can look up where to send packets.

To illustrate, each physical host device (e.g., a compute server, a block store server, an object store server, a control server) can have an IP address in the substrate network. Hardware virtualization technology can enable multiple operating systems to run concurrently on a host computer, for example as virtual machines (VMs) on a compute server. A hypervisor, or virtual machine monitor (VMM), on a host allocates the host's hardware resources amongst various VMs on the host and monitors the execution of the VMs. Each VM may be provided with one or more IP addresses in an overlay network, and the VMM on a host may be aware of the IP addresses of the VMs on the host. The VMMs (and/or other devices or processes on the network substrate) may use encapsulation protocol technology to encapsulate and route network packets (e.g., client IP packets) over the network substrate between virtualized resources on different hosts within the cloud provider network 203. The encapsulation protocol technology may be used on the network substrate to route encapsulated packets between endpoints on the network substrate via overlay network paths or routes. The encapsulation protocol technology may be viewed as providing a virtual network topology overlaid on the network substrate. The encapsulation protocol technology may include the mapping service that maintains a mapping directory that maps IP overlay addresses (e.g., IP addresses visible to customers) to substrate IP addresses (IP addresses not visible to customers), which can be accessed by various processes on the cloud provider network 203 for routing packets between endpoints.

The traffic and operations of the cloud provider network substrate may broadly be subdivided into two categories in various embodiments: control plane traffic carried over a logical control plane and data plane operations carried over a logical data plane. While the data plane represents the movement of user data through the distributed computing system, the control plane represents the movement of control signals through the distributed computing system. The control plane generally includes one or more control plane components or services distributed across and implemented by one or more control servers. Control plane traffic generally includes administrative operations, such as establishing isolated virtual networks for various customers, monitoring resource usage and health, identifying a particular host or server at which a requested compute instance is to be launched, provisioning additional hardware as needed, and so on. The data plane includes customer resources that are implemented on the cloud provider network 203 (e.g., computing instances, containers, block storage volumes, databases, file storage). Data plane traffic generally includes non-administrative operations such as transferring data to and from the customer resources.

The control plane components are typically implemented on a separate set of servers from the data plane servers, and control plane traffic and data plane traffic may be sent over separate/distinct networks. In some embodiments, control plane traffic and data plane traffic can be supported by different protocols. In some embodiments, messages (e.g., packets) sent over the cloud provider network 203 include a flag to indicate whether the traffic is control plane traffic or data plane traffic. In some embodiments, the payload of traffic may be inspected to determine its type (e.g., whether control or data plane). Other techniques for distinguishing traffic types are possible.

The data plane can include one or more computing devices 221, which may be bare metal (e.g., single tenant) or may be virtualized by a hypervisor to run multiple VMs or machine instances 224 or microVMs for one or more customers. These compute servers can support a virtualized computing service (or “hardware virtualization service”) of the cloud provider network 203. The virtualized computing service may be part of the control plane, allowing customers to issue commands via an API 215 to launch and manage compute instances (e.g., VMs, containers) for their applications. The virtualized computing service may offer virtual compute instances with varying computational and/or memory resources. In one embodiment, each of the virtual compute instances may correspond to one of several instance types. An instance type may be characterized by its hardware type, computational resources (e.g., number, type, and configuration of CPUs or CPU cores), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics. Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification.

The data plane can also include one or more block store servers, which can include persistent storage for storing volumes of customer data, as well as software for managing these volumes. These block store servers can support a block data storage service 212 of the cloud provider network 203. The block data storage service 212 may be part of the control plane, allowing customers to issue commands via the API 215 to create and manage volumes for their applications running on compute instances. The block store servers include one or more servers on which data is stored as blocks. A block is a sequence of bytes or bits, usually containing some whole number of records, having a maximum length of the block size. Blocked data is normally stored in a data buffer and read or written a whole block at a time. In general, a volume can correspond to a logical collection of data, such as a set of data maintained on behalf of a user. User volumes, which can be treated as an individual hard drive ranging for example from 1 GB to 1 terabyte (TB) or more in size, are made of one or more blocks stored on the block store servers. Although treated as an individual hard drive, it will be appreciated that a volume may be stored as one or more virtualized devices implemented on one or more underlying physical host devices. Volumes may be partitioned a small number of times (e.g., up to 16) with each partition hosted by a different host.

The data of the volume may be replicated between multiple devices within the cloud provider network 203, in order to provide multiple replicas of the volume (where such replicas may collectively represent the volume on the computing system). Replicas of a volume in a distributed computing system can beneficially provide for automatic failover and recovery, for example by allowing the user to access either a primary replica of a volume or a secondary replica of the volume that is synchronized to the primary replica at a block level, such that a failure of either the primary or secondary replica does not inhibit access to the information of the volume. The role of the primary replica can be to facilitate reads and writes (sometimes referred to as “input output operations,” or simply “I/O operations”) at the volume, and to propagate any writes to the secondary replica (preferably synchronously in the I/O path, although asynchronous replication can also be used).

The secondary replica can be updated synchronously with the primary replica and provide for seamless transition during failover operations, whereby the secondary replica assumes the role of the primary replica, and either the former primary is designated as the secondary or a new replacement secondary replica is provisioned. Although certain examples herein discuss a primary replica and a secondary replica, it will be appreciated that a logical volume can include multiple secondary replicas. A compute instance can virtualize its I/O to a volume by way of a client. The client represents instructions that enable a compute instance to connect to, and perform I/O operations at, a remote data volume (e.g., a data volume stored on a physically separate computing device accessed over a network). The client may be implemented on an offload device of a server that includes the processing units (e.g., CPUs or GPUs) of the compute instance.

The data plane can also include storage services for one or more object store servers, which represent another type of storage within the cloud provider network 203. The object storage servers include one or more servers on which data is stored as objects within resources referred to as buckets and can be used to support a managed object storage service of the cloud provider network 203. Each object typically includes the data being stored, a variable amount of metadata that enables various capabilities for the object storage servers with respect to analyzing a stored object, and a globally unique identifier or key that can be used to retrieve the object. Each bucket is associated with a given user account. Customers can store as many objects as desired within their buckets, can write, read, and delete objects in their buckets, and can control access to their buckets and the objects contained therein. Further, in embodiments having a number of different object storage servers distributed across different ones of the regions described above, users can choose the region (or regions) where a bucket is stored, for example to optimize for latency. Customers may use buckets to store objects of a variety of types, including machine images that can be used to launch VMs, and snapshots that represent a point-in-time view of the data of a volume.

The computing devices 221 may have various forms of allocated computing capacity 227, which may include virtual machine (VM) instances, containers, serverless functions, and so forth. The VM instances may be instantiated from a VM image. To this end, customers may specify that a virtual machine instance should be launched in a particular type of computing device 221 as opposed to other types of computing devices 221. In various examples, one VM instance may be executed singularly on a particular computing device 221, or a plurality of VM instances may be executed on a particular computing device 221. Also, a particular computing device 221 may execute different types of VM instances, which may offer different quantities of resources available via the computing device 221. For example, some types of VM instances may offer more memory and processing capability than other types of VM instances.

A cloud provider network 203 can be formed as a plurality of regions 230, where a region 230 is a separate geographical area in which the cloud provider has one or more data centers. Each region 230 can include two or more availability zones (AZs) 233 connected to one another via a private high-speed network such as, for example, a fiber communication connection. An availability zone 233 refers to an isolated failure domain including one or more data center facilities with separate power, separate networking, and separate cooling relative to other availability zones. A cloud provider may strive to position availability zones 233 within a region 230 far enough away from one another such that a natural disaster, widespread power outage, or other unexpected event does not take more than one availability zone offline at the same time. Customers can connect to resources within availability zones 233 of the cloud provider network 203 via a publicly accessible network (e.g., the Internet, a cellular communication network, a communication service provider network). Transit Centers (TC) are the primary backbone locations linking customers to the cloud provider network 203 and may be co-located at other network provider facilities (e.g., Internet service providers, telecommunications providers). Each region 230 can operate two or more TCs for redundancy. Regions 230 are connected to a global network which includes private networking infrastructure (e.g., fiber connections controlled by the cloud service provider) connecting each region 230 to at least one other region. The cloud provider network 203 may deliver content from points of presence (PoPs) outside of, but networked with, these regions 230 by way of edge locations and regional edge cache servers. This compartmentalization and geographic distribution of computing hardware enables the cloud provider network 203 to provide low-latency resource access to customers on a global scale with a high degree of fault tolerance and stability.

Various applications and/or other functionality may be executed in the cloud provider network 203 according to various embodiments. The components executed on the cloud provider network 203, for example, include one or more instance managers 236, one or more container orchestration services 239, one or more migration services 242, and other applications, services, processes, systems, engines, or functionality not discussed in detail herein. The instance manager 236 is executed to manage a pool of machine instances 224 in the cloud provider network 203 in order to provide a container execution environment 100 (FIGS. 1A-1C). The instance manager 236 may monitor the usage of the container execution environment 100 and scale the quantity of machine instances 224 up or down as demand warrants. In some embodiments, the instance manager 236 may also manage substrate machine instances 245 and/or off-load devices 118 in the cloud provider network 203. This may entail scaling a quantity of substrate machine instances 245 up or down as demand warrants, deploying additional instances of components in the container control plane 114, such as the container runtime 246 and the container orchestration agent 248, based on demand, moving the components of the container control plane 114 to higher or lower capacity substrate machine instances 245 or to and from the off-load devices 118.

The container orchestration service 239 is executed to manage the lifecycle of container instances 112, including provisioning, deployment, scaling up, scaling down, networking, load balancing, and other functions. The container orchestration services 239 accomplishes these functions by way of container orchestration agents 248 that are deployed typically on the same machine instance 224 as the container instance 112. In various embodiments, the container orchestration agents 248 are deployed on computing capacity 227 that is separate from the machine instance 224 on which the container instance 112 is executed, for example, on a substrate machine instance 245 or an off-load device 118. Non-limiting examples of commercially available container orchestration services 239 include KUBERNETES, APACHE MESOS, DOCKER orchestration tools, and so on. An individual instance of the container orchestration service 239 may manage container instances 112 for a single customer or multiple customers of the cloud provider network 203 via the container orchestration agent(s) 248.

The migration service 242 is executed to manage the live update and migration of the components of the container control plane 114, such as the container runtime 246 and the container orchestration agent 248. As new or updated versions of the container runtime 246 and the container orchestration agent 248 become available, the migration service 242 replaces the previous versions without rebooting or terminating the affected container instances 112.

The block data storage service 212 provides block data service for the machine instances 224. In various embodiments, the block data storage service 212 stores container images 127, machine images 251, and/or other data. The container images 127 correspond to container configurations created by customers, which include applications and their dependencies. The container images 127 may be compatible with one or more types of operating systems. In some cases, the container images 127 may be updated with a modified state of a container instance 112. In some implementations, the container images 127 are compatible with an Image Specification from the Open Container Initiative.

The machine images 251 correspond to physical or virtual machine system images, including an operating system and supporting applications and configurations. The machine images 251 may be created by the cloud provider and may not be modified by customers. The machine images 251 are capable of being instantiated into the machine instances 224 or the substrate machine instances 245.

The machine instances 224 perform the container execution for the container execution environments 100. In various examples, the machine instances 224 may include an operating system kernel 106, one or more container control plane interfaces 253, such as a container runtime interface 254 and/or a container orchestration agent interface 257, one or more container instances 112, and a read/write layer 124. The operating system kernel 106 may correspond to a LINUX, BSD, or other kernel in various examples. The operating system kernel 106 may manage system functions such as processor, memory, input/output, networking, and so on, through system calls and interrupts. The operating system kernel 106 may include a scheduler that manages concurrency of multiple threads and processes. In some cases, a user space controller provides access to functions of the operating system kernel 106 in user space as opposed to protected kernel space.

The container control plane interfaces 253 act as communication interfaces allowing the operating system kernel 106 and the container instances 112 to communicate with the components of the container control plane 114. The container runtime interface 254 acts as a lightweight shim to provide access to the container runtime 246. The container runtime interface 254 receives API calls, marshals parameters, and forwards the calls to the container runtime 246. The container orchestration agent interface 257 acts as a lightweight shim to provide access to the container orchestration agent 248. The container orchestration agent interface 257 receives API calls, marshals parameters, and forwards the calls to the container orchestration agent 248.

The confidential computing agent 258 may be executed in the machine instance 224, at the hypervisor layer, or at a lower hardware layer (e.g., embedded in a memory controller and/or a processor) in order to encrypt the physical memory that includes the machine instance 224. Encrypting the physical memory may be used in order to make the content of the container instance 112 confidential with respect to the cloud provider. A non-limiting commercially available example is Secure Encrypted Virtualization from ADVANCED MICRO DEVICES, INC. While the cloud provider typically would have access to manage the container control plane 114, by executing the container control plane 114 in the off-load device 118, the container control plane 114 is separated from the container instance 112. Thus, the physical memory including the container instance 112 can be encrypted without the cloud provider having access in order to manage the container control plane 114.

The container instances 112 are instances of the container that are executed in the machine instance 224. The read/write layer 124 provides the container instances 112 with access to the block data storage service 212, potentially through a mapped drive or other approach for providing block data to the container instance 112.

The substrate machine instances 245 may be executed in the substrate of the cloud provider network 203 to provide a separate execution environment for instances of the components of the container control plane 114, including container runtime 246 and the container orchestration agent 248. Non-limiting examples of the container runtime 246 may include container, CRI-O, DOCKER, and so on. The container runtime 246 may meet a Runtime Specification of the Open Container Initiative. Off-load devices 118 may be used in place of or in addition to the substrate machine instances 245 to execute the container runtime 246 and/or the container orchestration agent 248.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 206 may include a display that may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 279 and/or other applications. The client application 279 may be executed in a client device 206, for example, to access network content served up by the cloud provider network 203 and/or other servers, thereby rendering a user interface on the display. To this end, the client application 279 may comprise, for example, a browser, a dedicated application, etc., and the user interface may comprise a network page, an application screen, etc. The client device 206 may be configured to execute applications beyond the client application 279 such as, for example, email applications, social networking applications, word processors, spreadsheets, and/or other applications.

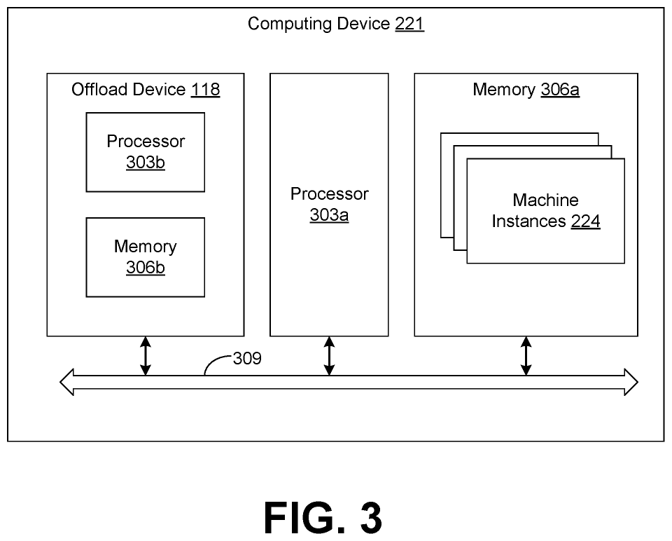

Turning now to FIG. 3, shown is a schematic block diagram of one example of a computing device 221 having an off-load device 118 (FIG. 2) according to various embodiments. The computing device 221 includes one or more processors 303a and one or more memories 306a that are coupled to a local hardware interconnect interface 309 such as a bus. Stored in the memory 306a and executed on the processor 303a are one or more machine instances 224. The off-load device 118 is also coupled to the local hardware interconnect interface 309, for example, by way of a Peripheral Component Interconnect (PCI) or PCI Express (PCIe) bus. For example, the off-load device 118 may correspond to a physical card that is pluggable into a connector on the bus. The off-load device 118 includes one or more processors 303b that are used to execute the container runtime 246 (FIG. 2) and/or the container orchestration agent 248 (FIG. 2). The processors 303a and 303b may have different processor architectures. For example, the processor 303a may have an ×86 architecture, while the processor 303b may have an ARM architecture. The off-load device 118 may have a memory 306b that is separate from the memory 306a.

In some implementations, at least a subset of virtualization management tasks may be performed at one or more off-load devices 118 operably coupled to a host computing device via a hardware interconnect interface so as to enable more of the processing capacity of the host computing device to be dedicated to client-requested machine instances—e.g., cards connected via PCI or PCIe to the physical CPUs and other components of the virtualization host may be used for some virtualization management components. The processor(s) 303b are not available to customer machine instances, but may be used for instance management tasks such as virtual machine management (e.g., a hypervisor), input/output virtualization to network-attached storage volumes, local migration management tasks, instance health monitoring, and the like.

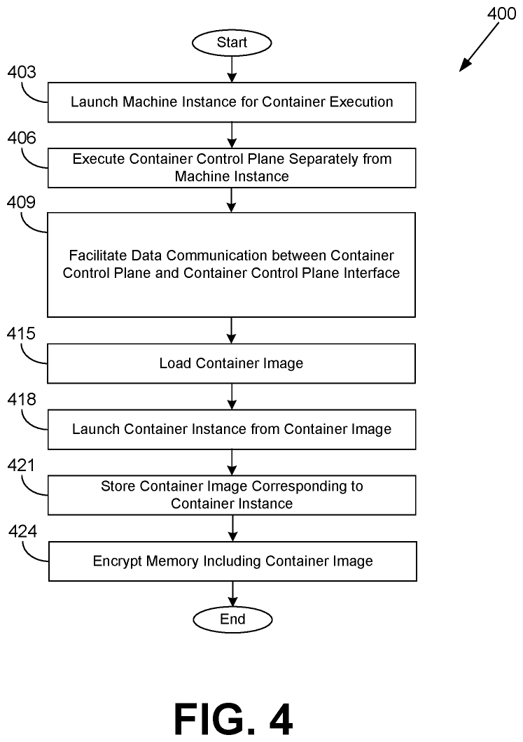

Referring next to FIG. 4, shown is a flowchart 400 that provides one example of the operation of a portion of the cloud provider network 203 (FIG. 2) according to various embodiments. It is understood that the flowchart 400 of FIG. 4 provides merely an example of the many different types of functional arrangements that may be employed to implement the operation of the portion of the cloud provider network 203 as described herein. As an alternative, the flowchart 400 of FIG. 4 may be viewed as depicting an example of elements of a method implemented in the cloud provider network 203 according to one or more embodiments.

Beginning with box 403, the instance manager 236 (FIG. 2) launches one or more machine instances 224 (FIG. 2) for container execution. The machine instances 224 may be launched from a machine image 251 (FIG. 2) obtained from the block data storage service 212 (FIG. 2). For example, the machine instances 224 may be executed in one or more processors located on a mainboard or motherboard of a computing device 221 (FIG. 2). In box 406, the instance manager 236 executes a container control plane 114 (FIG. 2), which may include a container runtime 246 (FIG. 2) and/or a container orchestration agent 248 (FIG. 2), separately from the machine instance 224 in either a substrate machine instance 245 (FIG. 2) launched from another machine image 251 or an off-load device 118 (FIG. 2) of a computing device 221 on which the machine instance 224 is executed. Also, the container control plane 114 may be stored in a memory of the off-load device 118 that is inaccessible to the container instance 112 (FIG. 2).

In box 409, the machine instance 224 facilitates data communication between the container control plane 114 and one or more container control plane interfaces 253 (FIG. 2) that are executed on the machine instance 224. In one example, the machine instance 224 may facilitate data communication between the container runtime 246 and the container runtime interface 254 (FIG. 2) that is executed on the machine instance 224. In another example, the machine instance 224 may facilitate data communication between the container orchestration agent 248 and the container orchestration agent interface 257 (FIG. 2) that is executed on the machine instance 224.

In box 415, the container orchestration agent 248 causes a container image 127 (FIG. 2) to be loaded from the block data storage service 212 via the read/write layer 124 (FIG. 2). In box 418, the container orchestration agent 248 launches a container instance 112 from the container image 127, so that the container instance 112 is executed in the machine instance 224 by the container runtime 246 that provides operating system-level virtualization, such as kernel namespaces and control groups to limit resource consumption.

As the container instance 112 is executed, the state in the container instance 112 may be modified. In box 421, the container orchestration agent 248 causes a container image 127 to be stored via the read/write layer 124 and the block data storage service 212, where the container image 127 corresponds to the container instance 112 with the modified state.

In box 424, the confidential computing agent 258 (FIG. 2) may encrypt a physical memory of the computing device 221 hosting the machine instance 224 that is executing the container instance 112. The encrypted physical memory may include the container instance 112, the operating system kernel 106, and/or other code and data from the machine instance 224. However, as the container control plane 114 is executed separately from the machine instance 224, the container control plane 114 is not included in the encrypted physical memory. Further, the container control plane 114 may be denied access to the encrypted physical memory, meaning that communication between the container control plane 114 and the container control plane interfaces 253 may take place by way of remote procedure call or similar approaches rather than the container control plane 114 having direct memory access. Accordingly, if the cloud provider should desire access to manage the container control plane 114, the cloud provider does not require access to the encrypted physical memory, thereby providing for confidentiality of the customer's data in the container instance 112. Thereafter, the flowchart 400 ends.

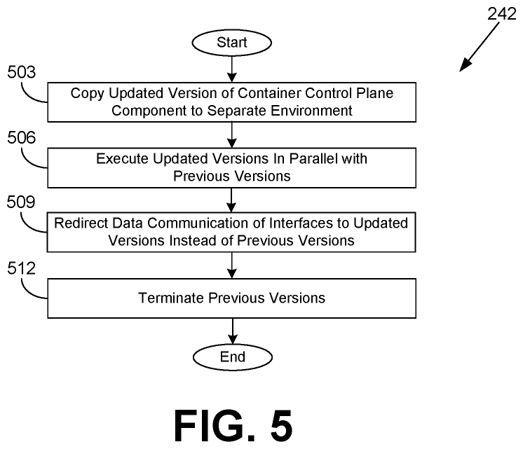

Referring next to FIG. 5, shown is a flowchart that provides one example of the operation of a portion of the migration service 242 according to various embodiments. It is understood that the flowchart of FIG. 5 provides merely an example of the many different types of functional arrangements that may be employed to implement the operation of the portion of the migration service 242 as described herein. As an alternative, the flowchart of FIG. 5 may be viewed as depicting an example of elements of a method implemented in the cloud provider network 203 (FIG. 2) according to one or more embodiments.

Beginning with box 503, the migration service 242 copies an updated version of a component of the container control plane 114 (FIG. 2), such as the container runtime 246 (FIG. 2) and/or an updated version of the container orchestration agent 248 (FIG. 2), to the environment where they are executed separately from the machine instances 224 (FIG. 2). In various embodiments, the migration service 242 may copy the updated versions to an off-load device 118 (FIG. 2) or to a substrate machine instance 245 (FIG. 2).

In box 506, the migration service 242 executes the updated versions of the component, such as the container runtime 246 and/or the container orchestration agent 248, in parallel with the previous versions. In box 509, the migration service 242 redirects the data communication between the container control plane interfaces 253 (FIG. 2) to point to the updated version instead of the previous version. For example, the migration service 242 may redirect the container runtime interface 254 (FIG. 2) and the container runtime 246 to point to the updated version instead of the previous version. Likewise, the migration service 242 may redirect the data communication between the container orchestration agent interface 257 (FIG. 2) and the container orchestration agent 248 to point to the updated version instead of the previous version.

In box 512, the migration service 242 may terminate the previous versions of the component of the container control plane 114, such as the container runtime 246 and the container orchestration agent 248. As the container instances 112 are now interacting with the updated versions, terminating the previous versions does not impact the operation of the container instances 112. Thereafter, the operation of the portion of the migration service 242 ends.

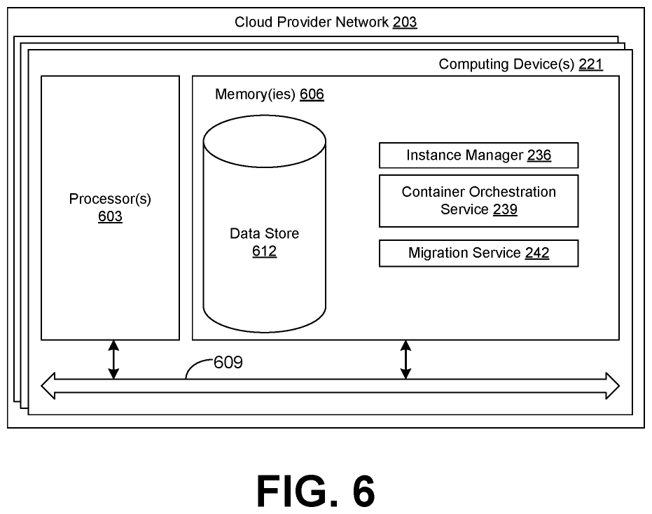

With reference to FIG. 6, shown is a schematic block diagram of the cloud provider network 203 according to an embodiment of the present disclosure. The cloud provider network 203 includes one or more computing devices 221. Each computing device 221 includes at least one processor circuit, for example, having a processor 603 and a memory 606, both of which are coupled to a local interface 609. To this end, each computing device 221 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the instance manager 236, the container orchestration service 239, the migration service 242, and potentially other applications. Also stored in the memory 606 may be a data store 612 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the instance manager 236, the container orchestration service 239, the migration service 242, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of the cloud provider network 203 and the migration service 242. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the instance manager 236, the container orchestration service 239, and the migration service 242, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the instance manager 236, the container orchestration service 239, and the migration service 242, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 221, or in multiple computing devices 221 in the same cloud provider network 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a computing device executing a virtual machine instance, the computing device comprising a first processor on which the virtual machine instance is executed; and
an off-load device operably coupled to the computing device via a hardware interconnect interface, the off-load device comprising a second processor, wherein the offload device is configured to execute, by the second processor, a container runtime and a container orchestration agent outside of the virtual machine instance, and
wherein the computing device is configured to at least:
execute, by the first processor, an operating system kernel, a container runtime interface, a container orchestration agent interface, and a container in the virtual machine instance;
facilitate data communication between the container runtime interface and the container runtime so that the container runtime performs operating system-level virtualization for the container; and
facilitate data communication between the container orchestration agent interface and the container orchestration agent so that the container orchestration agent performs an orchestration function for the container.

2. The system of claim 1, wherein the container runtime performs the operating system-level virtualization for the container and at least one other container executed by the first processor in a different virtual machine instance.

3. The system of claim 2, wherein the container and the at least one other container are associated with different accounts with the cloud provider network.

4. The system of claim 1, wherein the container orchestration agent performs the orchestration function for the container and at least one other container executed by the first processor in a different virtual machine instance.

5. The system of claim 1, wherein the computing device is further configured to at least:
launch, by the first processor, the container from a container image loaded from a block data storage service; and
store, by the first processor, an updated version of the container image via the block data storage service, the updated version of the container image incorporating a state modification from the container.

6. The system of claim 1, wherein the computing device is further configured to at least:
execute, in parallel with the container runtime, an updated version of the container runtime by the second processor;
execute, in parallel with the container orchestration agent, an updated version of the container orchestration agent by the second processor;
redirect the data communication from the container orchestration agent interface to the updated version of the container orchestration agent instead of the container orchestration agent; and
redirect the data communication from the container runtime interface to the updated version of the container runtime instead of the container runtime.

7. The system of claim 1, wherein the first processor has a first processor architecture, and the second processor has a second processor architecture that is different from the first processor architecture.

8. The system of claim 1, wherein the first processor is on a mainboard of the computing device, and the off-load device is coupled to a bus of the computing device.

9. The system of claim 1, wherein the computing device is further configured to at least encrypt a physical memory storing the virtual machine instance, the encrypted physical memory being inaccessible to the second processor.

10. A computer-implemented method, comprising:
executing a container in a virtual machine instance running on a computing device;
executing a container control plane separately from the virtual machine instance in an off-load device operably coupled to the computing device via a hardware interconnect interface; and
managing the container using the container control plane executing on the off-load device.

11. The computer-implemented method of claim 10, further comprising loading the container from a container image stored by a block data storage service in data communication with the virtual machine instance.

12. The computer-implemented method of claim 10, wherein the container control plane includes at least a container runtime and a container orchestration agent.

13. The computer-implemented method of claim 10, further comprising:
executing, in parallel with a first component version of the container control plane, a second component version of the container control plane separately from the virtual machine instance in the off-load device; and
redirecting data communication from an interface for the container control plane to the second component version of the container control plane instead of the first component version of the container control plane.

14. The computer-implemented method of claim 10, wherein the container control plane performs operating system-level virtualization for the container and at least one different container executed in a different machine instance.

15. The computer-implemented method of claim 10, further comprising executing an operating system kernel and an interface for the container control plane in a first processor of the computing device; and
wherein executing the container control plane separately from the virtual machine instance in the off-load device further comprises executing the container control plane in a second processor in the off-load device.

16. A computer-implemented method, comprising:
executing a container and an interface for a container control plane in a machine instance of a computing device;
executing the container control plane in an off-load device of the computing device; and
encrypting a physical memory of the computing device, the container control plane being excluded from the encrypted physical memory.

17. The computer-implemented method of claim 16, further comprising facilitating data communication between the interface for the container control plane and the container control plane.

18. The computer-implemented method of claim 16, further comprising denying access by the container control plane to the encrypted physical memory.

19. The computer-implemented method of claim 16, further comprising storing the container control plane in a memory of the off-load device that is inaccessible to the container.

20. The computer-implemented method of claim 16, further comprising:
launching the container from a container image loaded from a block data storage service; and
storing an updated version of the container image via the block data storage service, the updated version of the container image incorporating a state modification from the container.
